(19) United States
(12) Patent Application Publication
(10) Pub. No.: US 2008/0148555 A1
(43) Pub. Date: Jun. 26, 2008

(54) Method Of Manufacturing An Electrochemical Energy Source,Electrochemical Energy Source Thus Obtained And Electronic Device

(75) Inventors: Freddy Roozeboom, Eindhoven (NL); Peter Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,759

(22) PCT Filed: Feb. 17, 2006
(86) PCT No.: PCT/IB06/50525

§ 371 Date: Aug. 21, 2007

(30) Foreign Application Priority Data
Mar. 3, 2005 (EP) 05101661.6

(51) Int. Cl. H01M 6/00

(52) U.S. Cl. 29/623.1

(57) ABSTRACT

The invention relates to a method of manufacturing an electrochemical energy source comprising the steps of providing a first electrode that is at least partially formed by a conducting substrate, depositing a lithium ion solid-state electrolyte on the substrate; and depositing a second electrode on the substrate. The lithium ion solid-state electrolyte layer is obtained from a dual metal lithium alkoxide precursor Further an electrochemical energy source is disclosed as well as an electronic device provided with such an electrochemical energy source.

The invention relates to a method of manufacturing an electrochemical energy source comprising the steps of providing a first electrode that is at least partially formed by a conducting substrate, depositing a lithium ion solid-state electrolyte on the substrate and subsequently depositing a second electrode on the substrate. The invention also relates to an electrochemical energy source thus obtained as well as to an electronic device provided with such an electrochemical energy source.

Electrochemical energy sources based on solid-state electrolytes are known in the art. These (planar) energy sources, or ‘solid-state batteries’, are constructed as stated in the preamble. Solid-state batteries efficiently and cleanly convert chemical energy directly into electrical energy and are often used as the power sources for portable electronics. At a smaller scale such batteries can be used to supply electrical energy to e.g. microelectronic modules, more particularly to integrated circuits (ICs). An example hereof is disclosed in international patent application WO 00/25378, where a solid-state thin-film micro battery is fabricated directly onto a specific substrate. During this fabrication process the first electrode, the intermediate solid-state electrolyte, and the second electrode are subsequently deposited onto the substrate.

In an earlier filed but not yet published patent application in the name of the Applicant an improved electrochemical energy source is provided, which can be constructed and manufactured in a relatively simple manner. To this end the electrochemical energy source is characterized in that said first electrode is formed at least partially by a conducting substrate on which the solid-state electrolyte and the second electrode are deposited. In this way the electron-conducting substrate also functions as at least a part of the first electrode. The integration of said substrate and at least a part of said first electrode leads commonly to a simpler construction of the (micro)battery compared to those known in the art. Moreover, the way of manufacturing an energy source according to the invention is also simpler, as at least one process step can be eliminated. The relatively simple manufacturing method of the solid-state energy source according to the invention may furthermore lead to significant cost saving. Preferably, the solid-state electrolyte and the second electrode are deposited on the substrate as thin film layers with a thickness of approximately between 0.5 and 5 micrometer. Thin film layers result in higher current densities and efficiencies because the transport of ions in the energy source is easier and faster through thin-film layers than through thick-film layers. In this way the internal energy loss may be minimized. As the internal resistance of the energy source is relatively low the charging speed may be increased when a rechargeable energy source is applied.

Thus for example a fully integrated solid-state chip for power back-up supply can be made in porous Si (or other porous substrate materials) with high-surface area by depositing a triple layer stack of 1) Li-ion intercalation (negative) electrode (e.g. conductive amorphous Si), 2) a Li-ion conducting layer as the solid state electrolyte (e.g. LiPON, Li-niobate [LiNbO₃], etc.) and 3) a LiCoOₓ layer as the (positive) counter-electrode.

Preferably, the first electrode comprises an electron-conducting barrier layer adapted to at least substantially preclude diffusion of intercalating ions into said substrate, said barrier layer being applied onto said substrate. This preferred embodiment is commonly very advantageous, since intercalating ions taking part in the (re)charge cycles of the electrochemical source according to the invention often diffuse into the substrate, such that these ions do no longer participate in the (re)charge cycles, resulting in a diminished storage capacity of the electrochemical source. Commonly, a monocrystalline silicon conductive substrate is applied to carry electronic components, such as integrated circuits, chips, displays, et cetera. This crystalline silicon substrate suffers from this drawback that the intercalating ions diffuse relatively easily into said substrate, resulting in a reduced capacity of said energy source. For this reason it is considerably advantageous to apply a barrier layer onto said substrate to preclude said unfavorable diffusion into the substrate. Migration of the intercalating ions will be blocked at least substantially by said barrier layer, as a result of which migration of these ions through the substrate will no longer occur, while migration of electrons through said substrate is still possible. According to this embodiment it is no longer necessary that the substrate is adapted to storage of the intercalating ions. Therefore, it is also possible to apply electron-conductive substrates other than silicon substrates, like substrates made of metals, conductive polymers, et cetera. Said barrier layer is at least substantially made of at least one of the following compounds: tantalum, tantalum nitride, and titanium nitride. The material of the barrier layer is however not limited to these compounds. These compounds have as common property a relatively dense structure which is impermeable to the intercalating ions, including lithium ions. In a particular, preferred embodiment the first electrode further comprises an intercalating layer deposited onto a side of said barrier layer opposite to the substrate. Said intercalating layer is thereby adapted to store (and release) the intercalating ions (temporarily). According to this embodiment the first electrode is thus formed by a laminate of said substrate, said barrier layer, and said intercalating layer. Commonly, the laminate will be formed by stacking (depositing) the barrier layer and the intercalating layer onto said substrate. However, in a particular embodiment the laminate can also be formed by means of implantation techniques, wherein for example a crystalline silicon substrate is bombarded with for example tantalum ions and nitrogen ions, after which the temperature of the implanted substrate is sufficiently raised to form the physical barrier layer buried within said original substrate. As a result of the bombardment of the silicon substrate with ions, commonly the lattice of the crystalline top layer of the original substrate will be destructed, resulting in an amorphous top layer forming said intercalating layer. In a preferred embodiment said intercalating layer is at least substantially made of silicon, preferably amorphous silicon. An amorphous silicon layer has the outstanding property to store (and release) relatively large amounts of intercalating ions per unit of volume, which results in an improved storage capacity of the electrochemical source according to the invention. Preferably, said barrier layer is deposited onto said substrate. Both said barrier layer and said intercalating layer are preferably deposited onto said substrate by way of low pressure Chemical Vapor Deposition (LPCVD).

The presently preferred method of depositing the solid-state electrolyte layer is low-pressure Metal-Organic Chemical Vapor Deposition (MOCVD), a chemical vapor deposition process that uses metal-organic compounds as source materials. This method has the inherent advantage of step-conformal layers with uniform layer thickness all along pores or trenches etched in the substrate to enhance the internal substrate area, and thus the energy density of the battery. However, MOCVD may suffer from the fact that the Li chemical precursors used have not the ideal physical and chemical properties, necessary for low-pressure and low-temperature MOCVD. This is the case for lithium, where the available Li-precursors are usually Li-alkoxides, such as Li-methoxide, Li-ethoxide Li-isopropoxide and Li-tertiary-butoxide, All these single-metal Li-precursors suffer from the fact that they are solid powders with high melting points (up to 500° C. for the methoxide) and low vapor pressure. Thus these precursors need to be dissolved in alcohols, etc. to allow some degree of vaporization and vapor pressure prior to dosage into an MOCVD deposition system. However, the vaporization is troublesome and not-well controlled in the course of time due to aging of the surface solid of the precursor, which is contained in a thermostated container (or MO source), leading to reduced vapor pressure. This limits the growth rate in the deposition process and complicates vapor pressure control, and thus the stoichiometry control of the electrolyte layer.

It is an object of the invention to overcome the above disadvantages. To this end the present invention provides for a method according to the preamble that is characterized in that the lithium ion solid-state electrolyte layer is obtained from a dual metal lithium alkoxide precursor.

By applying dual metal Li-M-alkoxides precursor materials, the advantageous low boiling points and vapor pressures of these liquids for application in MOCVD deposition are combined with higher growth rates and better stoichiometry control, resulting in the right stoichiometry needed in the desired end product, being the Li-ion conducting solid-state electrolyte layer (like Li-niobate [LiNbO3], etc. For example lithium-niobium butoxide, is a liquid with boiling point of 110° C. and vapor pressures of the order of 0.1 mmHg.

The stoichiometry control for growing the right electrolyte layer composition is much easier: the dual-metal alkoxides are liquids with low boiling point and high vapor pressures and inherently have Li: metal stoichiometry ratio matching to that in the desired solid-state electrolyte layer (e.g. 1:1 for Li—Nb and Li—Ta; 2:1 for Li—W).

Thus the Li-ion conducting solid-state electrolyte layer (like Li-niobate [LiNbO3], Li-tantalate [LiTaO₃], Li-orthotungstate [Li₂WO₄], etc.) can better be made from MOCVD precursor chemicals such as the corresponding dual-metal lithium alkoxides than from the mixed individual single metal precursors.

Preferably the dual metal lithium precursors are liquid organometallics compounds with low boiling point, sufficient vapor pressure at room or slightly elevated temperature, etc. and inherent Li: metal stoichiometry to easily form Li-ion conducting solid electrolyte layers like Li-niobate [LiNbO₃], which have inherently matching stoichiometry ratio (1:1 for Li—Nb or Li—Ta; or 2:1 for Li—W).

In a preferred embodiment, the dual metal lithium alkoxide precursor is chosen from the group comprising lithium niobium butoxide, lithium niobium isopropoxide and lithium tantalum ethoxide.

Lithium niobium butoxide has a boiling point of 110° C. and a vapor pressure in the order of 0.1 mmHg. Lithium niobium isopropoxide has a boiling point of 140° C. and a vapor pressure in the order of 0.2 mmHg and finally lithium tantalum ethoxide has a boiling point of 230° C. and a vapor pressure in the order of 0.2 mmHg.

In an advantageous embodiment, also the second electrode is obtained from a dual metal organometallic precursor. Such precursor is preferably chosen from the group of Li—Co or Li—Ni precursors, e.g. Li—Co isopropoxide or Li—Ni isopropoxide.

Both the Li-ion conducting electrolyte layer and the second electrode (or positive counterelectrode) can be deposited by Low Pressure-MOCVD and other related techniques, such as for example atomic layer deposition.

The present invention also relates to an electrochemical energy source that is obtained by the above method.

In a preferred embodiment of the electrochemical energy source a contact surface of the substrate facing the electrolyte and the second electrode is patterned at least partially. In this way an increased contact surface per volume between both electrodes and the solid-state electrolyte is obtained. Commonly, this increase of the contact surface(s) between the components of the energy source according to the invention leads to an improved rate capacity of the energy source, and hence a better battery capacity (due to an optimal utilization of the volume of the layers of the energy source). In this way the power density in the energy source may be maximized and thus optimized. The nature, shape, and dimensioning of the pattern may be arbitrary.

In general, the contact surface may be patterned in various ways, e.g. by providing extensions to the contact surface which project away from the contact surface. Preferably, the contact surface is provided with a plurality of cavities of arbitrary shape and dimension, said electrolyte and said second electrode being provided to at least a part of an inner surface of said cavities. This has the advantage that the patterned contact surface may be manufactured in a relatively simple way. In an embodiment the cavities are linked, enabling multiple protruding pillars to be formed on the substrate to increase the contact surface within the electrochemical energy source. In another preferred embodiment at least a part of the cavities form slits or trenches in which the solid-state electrolyte and the second electrode are deposited. The pattern, more particularly the cavities, on the contact surface of the conducting substrate may be formed for example by way of etching.

The invention further relates to an electronic module provided with at least one such electrochemical energy source. The electronic module may be formed by an integrated circuit (IC), microchip, display, et cetera. The combination of the electronic module and the electrochemical energy source may be constructed in a monolithic or non-monolithic way. In the case of a monolithic construction of said combination preferably a barrier layer for ions is applied between the electronic module and the energy source. In an embodiment the electronic module and the electrochemical energy source form a System in Package (SiP). The package is preferably non-conducting and forms a container for the afore-mentioned combination. In this way an autonomous ready-to-use SiP may be provided in which besides the electronic module an energy source according to the invention is provided. Said System in Package can also be a part of an autonomous device in an Ambient Intelligence network.

The invention further relates to an electronic device provided with at least one such electrochemical energy source or, preferably, one such electronic module. An example of such an electronic device is a shaver, wherein the electrochemical energy source may function for example as a backup (or primary) power source. Another example of an electric device wherein an energy source according to the invention may be incorporated is a so-called ‘smart-card’ containing a microprocessor chip. Current smart-cards require a separate bulky card reader to display the information stored on the card's chip. But with a, preferably flexible, micro battery, the smart-card may comprise for example a relatively tiny display screen on the card itself that allows users easy access to data stored on the smart-card.

1. Method of manufacturing an electrochemical energy source comprising the steps of:
providing a first electrode that is at least partially formed by a conducting substrate,
depositing a lithium ion solid-state electrolyte on the substrate; and
depositing a second electrode on the substrate,
characterized in that the lithium ion solid-state electrolyte layer is obtained from a dual metal lithium alkoxide precursor.

2. Method of manufacturing an electrochemical energy source according to claim 1, characterized in that the dual metal lithium alkoxide precursor is chosen from the group comprising lithium niobium butoxide, lithium niobium isopropoxide and lithium tantalum ethoxide.

3. Method of manufacturing an electrochemical energy source according to claim 1, characterized in that the second electrode is obtained from a dual metal organometallic precursor.

4. Method according to claim 3, characterized in that the dual metal organometallic precursor is chosen from the group of Li—Co or Li—Ni precursors.

5. Electrochemical energy source obtained by a method according to claim 1.

6. Electronic device provided with at least one electrochemical energy source according to claim 5.

7. Electronic device according to claim 6, characterized in that the electronic device is formed by an integrated circuit (IC).

8. Electronic device according to claim 6, characterized in that the electronic device and the electrochemical energy source form a System in Package (SiP).
